(19) United States
(12) Patent Application Publication
(10) Pub. No.: US 2006/0109585 A1
(43) Pub. Date: May 25, 2006

(54) Method and apparatus using micro-actuator stroke sensitivity estimates in a hard disk drive

(75) Inventors: Dong Jun Lee, Sunnyvale, CA (US); Young-Hoon Kim, Cupertino, CA (US); Vinod Sharma, Los Gatos, CA (US); Hyung Jai Lee, Cupertino, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/329,851

(22) Filed: Jan. 10, 2006

Related U.S. Application Data
(63) Continuation-in-part of application No. 10/886,171, filed on Jul. 6, 2004, now Pat. No. 7,009,803.

(51) Int. Cl. G11B 5/596

(52) U.S. Cl. 360/77.02

(57) ABSTRACT

Operating micro-actuator using stroke sensitivity estimate including controlling micro-actuator directing read-write head toward track using stroke sensitivity to create micro-actuator stimulus signal. Servo controller may support operating micro-actuator. Method of estimating may be used to create stroke sensitivity during at least initialization/calibration of manufacturing hard disk drive. Embedded circuit may include servo controller. Hard disk drive may include servo controller, possibly embedded circuit, coupled to voice coil motor, to provide micro-actuator stimulus signal driving micro-actuator. Invention includes making servo controller, possibly embedded circuit, and/or hard disk drive. Servo controller, embedded circuit, and hard disk drive are products of these processes.

### CROSS REFERENCES TO RELATED APPLICATIONS

This application is a continuation-in-part of U.S. application Ser. No. 10/886,171, filed Jul. 6, 2004, the specification of which is hereby incorporated by referenced in its entirety.

### TECHNICAL FIELD

This invention relates to hard disk drives, in particular, to methods and apparatus estimating the stroke sensitivity of a micro-actuator inside a hard disk drive, and operating the hard disk drive based upon that stroke sensitivity estimate.

### BACKGROUND OF THE INVENTION

Contemporary hard disk drives include an actuator assembly pivoting through an actuator pivot to position one or more read-write heads, embedded in sliders, each over a rotating disk surface. The data stored on the rotating disk surface is typically arranged in concentric tracks. To access the data of a track, a servo controller first positions the read-write head by electrically stimulating the voice coil motor, which couples through the voice coil and an actuator arm to move a head gimbal assembly in lateral positioning the slider close to the track. Once the read-write head is close to the track, the servo controller typically enters an operational mode known herein as track following. It is during track following mode that the read-write head is used to access data stored in the track.

Micro-actuators provide a second actuation stage for lateral positioning the read-write head during track following mode. They often use an electrostatic effect and/or a piezoelectric effect to rapidly make fine position changes. They have doubled the bandwidth of servo controllers and are believed essential for high capacity hard disk drives from hereon.

Using micro-actuator requires an accurate stroke sensitivity estimate. The stroke sensitivity is the displacement of the read-write head in the lateral plane for a given electrical stimulus. There are several difficulties associated with achieving this. The stroke sensitivity often needs to be measured on an individual basis, inside the assembled hard disk drive, during access operations. The stroke sensitivity measurements may need to be repeated as the hard disk drive ages and may differ for each of the micro-actuators and their coupled read-write heads.

There is also a question as to whether and how much a specific micro-actuator is aiding the track following process. One useful estimate of its contribution would be an effective estimate of its operational bandwidth, over which there is close to flat frequency response.

Finally, there is the need to calibrate each specific micro-actuator as to the details of its dynamics, including mode peaks, possibly related to air flow turbulence or other sources of mechanical vibration affecting the micro-actuator.

### SUMMARY OF THE INVENTION

The invention includes using an estimate of the stroke sensitivity of a micro-actuator coupled with a slider and its read-write head, which is the product of a method of estimating the stroke sensitivity, which includes the following. A micro-actuator stimulus signal is used to drive the micro-actuator, inducing noise into the lateral positioning of the read-write head near a track by the voice coil motor to create the Position Error Signal (PES). The lateral position noise is derived from the Position Error Signal. The stroke sensitivity is estimated based upon the later position noise and upon the micro-actuator stimulus signal.

The invention includes a method of operating the micro-actuator using the stroke sensitivity. This includes controlling the micro-actuator directing the read-write head toward the track using the stroke sensitivity to create the micro-actuator stimulus signal. The micro-actuator may be further controlled using the stroke sensitivity and based upon the Position Error Signal to create the micro-actuator stimulus signal. A servo controller may support the method of operating the micro-actuator.

The servo controller may include the servo computer accessibly coupled to the memory, and directed by a second program system including program steps residing in the memory, and/or a means for controlling the micro-actuator and/or a means for controlling the voice coil motor. The second program system may include the program step controlling the micro-actuator directing the read-write head toward the track using the stroke sensitivity to create the micro-actuator stimulus signal. At least one of the means for controlling the voice coil motor and/or the means for controlling the micro-actuator may include at least one of a second computer second accessibly coupled to a second memory and directed by a third program system, a finite state machine, and/or an Application Specific Integrated Circuit (ASIC).

In certain embodiments, the method of estimating may be used to create the stroke sensitivity during the initialization/calibration phase of manufacturing the hard disk drive. This stage often occurs after the hard disk drive is assembled. The method estimates the stroke sensitivity for at least one micro-actuator, and if the hard disk drive includes more than one micro-actuator, may preferably perform the estimate for each of the micro-actuators.

In certain embodiments, the method of estimating may be implemented as the program system with its program steps residing in a volatile memory component of the memory, the stroke sensitivity estimate or estimates are the product of this manufacturing process, which are usually stored in a non-volatile memory component of the memory. Alternatively, the program system may be implemented with its program steps residing in a non-volatile memory component of the memory. These embodiments are useful in estimating the stroke sensitivity throughout the life of the hard disk drive.

Making the servo controller and/or the embedded circuit including the servo controller may include installing the servo computer, the second program system, and the memory into the servo controller to create the embedded circuit (servo controller), and/or installing a means for controlling the voice coil motor and a means for controlling the micro-actuator to create the embedded circuit (servo controller).

The second program system may further support estimating the operational bandwidth of the micro-actuator. The operational bandwidth in certain instances may degrade over the life of the hard disk drive. When the operational bandwidth is non-functional the micro-actuator may be less useful, and in certain cases, may be non-functional.

A hard disk drive may include the servo controller, and possibly the embedded circuit, coupled to the voice coil motor, to provide the micro-actuator stimulus signal driving the micro-actuator, and a read differential signal pair from the read-write head to the servo controller to generate the Position Error Signal.

The invention includes making the servo controller, possibly the embedded circuit, as well as the hard disk drive. The servo controller, the embedded circuit, and the hard disk drive are products of these processes.

### BRIEF DESCRIPTION OF THE DRAWINGS

FIGS. 1 and 2 show simplified schematics of hard disk drives implementing the invention's methods of estimating and using the stroke sensitivity to operate the hard disk drive;

FIGS. 3A to 5F shows various implementation details related to FIGS. 1 and 2;

FIGS. 6A and 6B show some results of experiments involving the method of estimation;

FIGS. 7A to 8B show some further details of the method of estimation;

FIG. 8C shows some details of the invention's hard disk drive; and

FIGS. 10A to 12B show some details of using the stroke sensitivity as a product of the estimation process to operate the hard disk drive;

FIG. 13A shows some details of the hard disk drives of the previous Figures; and

FIGS. 13B and 14 show some details of head gimbal assemblies, in particular, their micro-actuators, as used in the invention's hard disk drives.

### DETAILED DESCRIPTION

This invention relates to hard disk drives, in particular, to methods and apparatus estimating the stroke sensitivity of a micro-actuator inside a hard disk drive, and operating the hard disk drive based upon that stroke sensitivity estimate.

The invention includes a method of estimating the stroke sensitivity of a micro-actuator coupled with a slider and its read-write head and a method of using the stroke sensitivity estimate to operate the hard disk drive.

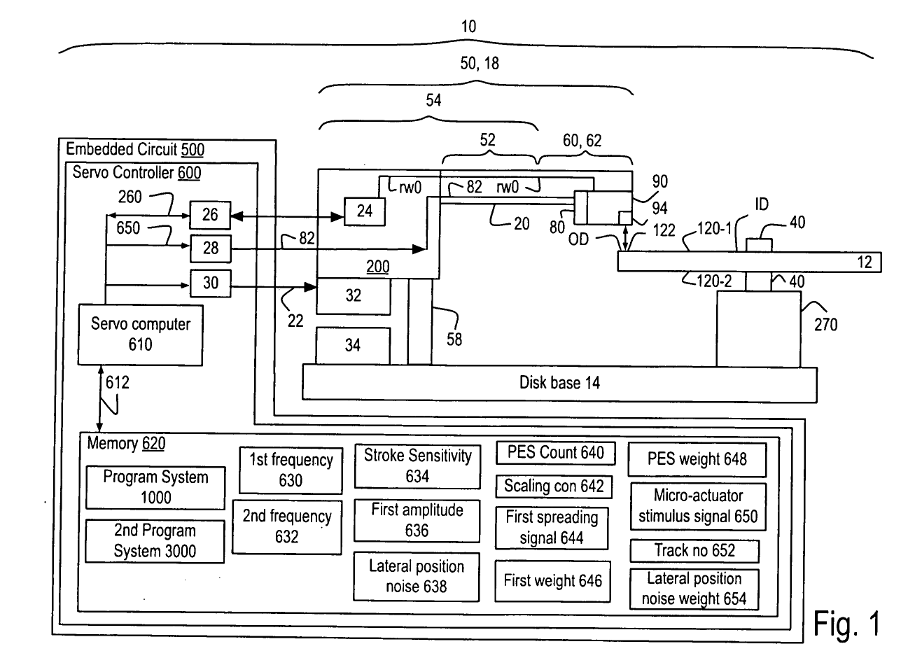

FIGS. 1, 2 and 9 point out some of the variations in implementation of the method for estimating, and/or using the estimate of, the stroke sensitivity 634. The servo controller 600, as shown in FIGS. 1 and 9, may include a servo computer 610 accessibly coupled 612 to a memory 620. A program system 1000 may direct the servo computer in implementing the method estimating the stroke sensitivity. A second program system 3000 may also direct the servo computer in using the estimated stroke sensitivity. Both the program system and the second program system include at least one program step residing in the memory.

The estimating method may be used within a hard disk drive 10 to estimate the stroke sensitivity 634 of a micro-actuator 80 coupled with a slider 90 and its read-write head 94. A micro-actuator stimulus signal 650 is used 1500 to drive the micro-actuator, inducing noise into the lateral positioning of the read-write head near a track 122 by the voice coil motor 18 to create the Position Error Signal 260 (PES). The lateral position noise 638 is derived 1510 from the Position Error Signal, which is often represented by a PES Count 640. The stroke sensitivity is estimated 1520 based upon the lateral position noise and upon the micro-actuator stimulus signal. These examples show the method implemented within a servo controller 600. FIG. 1 shows the servo controller included in an embedded circuit 500, which is preferred in certain embodiments. The embedded circuit may preferably be implemented with a printed circuit technology.

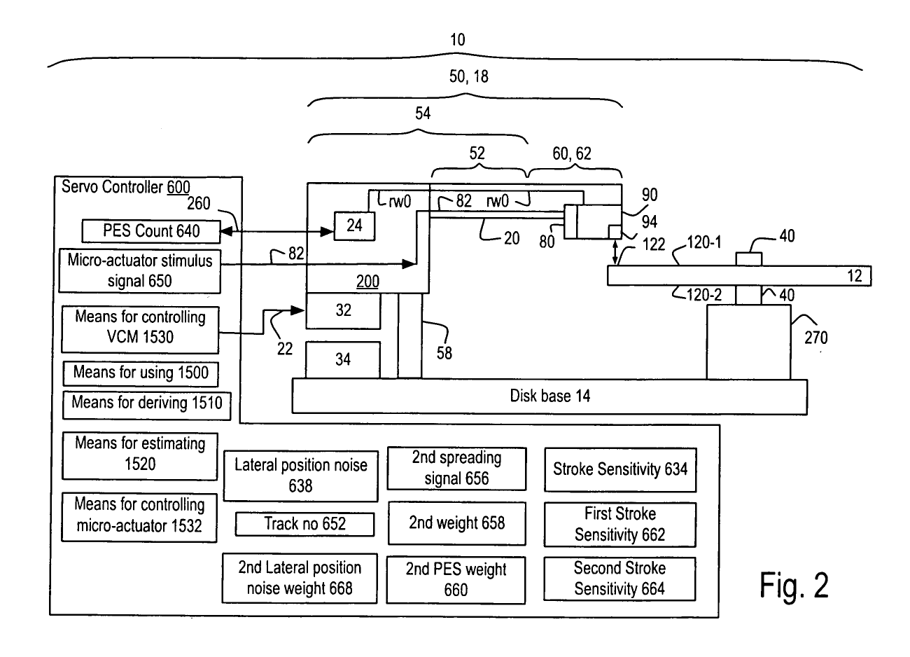

The servo controller 600 may further preferably include the means for controlling the voice coil motor 1530 to laterally position the read-write head 94 near the track 122 on the rotating disk surface 120-1, and the means for controlling the micro-actuator 1532 using the stroke sensitivity 634 to generate the micro-actuator stimulus signal 650, as shown in FIG. 2. The servo controller 600 may include a means for using 1500 the micro-actuator stimulus signal 650 driving the micro-actuator 80 to induce noise into the lateral positioning of the read-write head 94 near the track 122 by the voice coil motor 18 to create the Position Error Signal 260, means for deriving 1510 the lateral position noise 638 from the Position Error Signal, and means for estimating 1520 the stroke sensitivity 634 based upon the lateral position noise and upon the micro-actuator stimulus signal.

At least one member of the means group may include at least one of a computer accessibly coupled to a memory and directed by a program system including at least one program step residing in the memory, a finite state machine, and an Application Specific Integrated Circuit (ASIC). The means group may consist of the means for controlling the voice coil motor 1530, the means for controlling the micro-actuator 1532, the means for using 1500, the means for deriving 1510, and the means for estimating 1520.

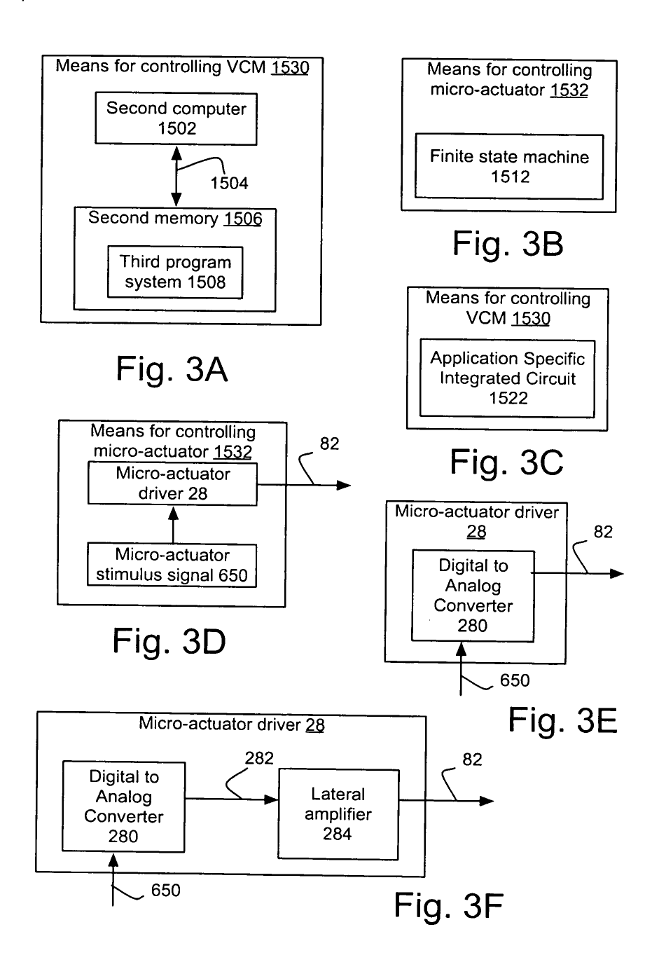

Examples of these embodiments are shown in FIGS. 3A to 3C. The means for controlling the voice coil motor 1530 is shown including a second computer 1502 second accessibly coupled 1504 to a second memory 1506, which includes program steps of a third program system 1508. The means for control the micro-actuator 1532 includes a finite state machine 1512 and/or an Application Specific Integrated Circuit 1522.

FIG. 3D shows the means for controlling the micro-actuator 1532 including the micro-actuator stimulus signal, which may include the micro-actuator stimulus signal 650 driving a micro-actuator driver 28 providing a lateral control signal 82 to the micro-actuator 80 similarly to the example shown in FIG. 1, where the micro-actuator may respond to the lateral control signal to induce the noise into the lateral positioning of the read-write head 94 near the track 122 by the voice coil motor 18. The micro-actuator driver may also provide the lateral control signal to the micro-actuator similarly to the example shown in FIG. 9, where the micro-actuator may respond to the lateral control signal to aid the voice coil motor in lateral positioning the read-write head near the track.

FIGS. 3E to 3F show some details of examples of the micro-actuator driver 28 of FIGS. 1, 3D and 9. The micro-actuator driver may include a digital to analog converter 280 contributing to the lateral control signal 82. The micro-actuator driver may further include the digital to analog converter providing its DAC output 282 to a lateral amplifier 284 to further contribute to the lateral control signal.

In more detail, the micro-actuator stimulus signal 650 driving the micro-actuator driver 28 may include the micro-actuator stimulus signal feeding a digital to analog converter providing a first micro-actuator driving signal contributing to the lateral control signal. Further, the micro-actuator stimulus signal 650 feeding the digital to analog converter may include the first micro-actuator driving signal presented to a first amplifier providing a first amplified signal further contributing to the lateral control signal. The first amplifier providing the first amplified signal may include the first amplified signal presented to a first filter to provide the lateral control signal.

Alternatively, the micro-actuator stimulus signal 650 driving the micro-actuator driver 28 may include the first micro-actuator driving signal presented to a second filter providing a second filtered signal further contributing to the lateral control signal. The second filter providing a second filtered signal may include the second filtered signal presented to a second amplifier providing the lateral control signal.

While the invention claims and discloses that the servo controller may include more than one computer embodying the various means as discussed before, for the sake of simplifying the discussion, we will proceed by discussing only the embodiment where there is one computer, the servo computer. It is common that the hard disk drive and/or the embedded circuit contain a second computer, which often deals with error control coding/decoding of tracks and memory management tasks.

A computer as used herein may include at least one instruction processor and at least one data processor, where each of the data processors is directed by at least one of the instruction processors.

The following Figures include flowcharts of at least one method of the invention possessing arrows. These arrows will signify of flow of control and sometimes data, supporting implementations including at least one program step or program thread executing upon a computer, inferential links in an inferential engine, state transitions in a finite state machine, and learned responses within a neural network.

The operation of starting a flowchart refers to at least one of the following and is denoted by an oval with the text “Start” in it. Entering a subroutine in a macro-instruction sequence in a computer. Entering into a deeper node of an inferential graph. Directing a state transition in a finite state machine, possibly while pushing a return state. And triggering at least one neuron in a neural network.

The operation of termination in a flowchart refers to at least one of the following and is denoted by an oval with the text “Exit” in it. The completion of those steps, which may result in a subroutine return, traversal of a higher node in an inferential graph, popping of a previously stored state in a finite state machine, return to dormancy of the firing neurons of the neural network.

An operation in a flowchart refers to at least one of the following. The instruction processor responds to the operation as a program step to control the data execution unit in at least partly implementing the step. The inferential engine responds to the operation as nodes and transitions within an inferential graph based upon and modifying a inference database in at least partly implementing the operation. The neural network responds to the operation as stimulus in at least partly implementing the operation. The finite state machine responds to the operation as at least one member of a finite state collection comprising a state and a state transition, implementing at least part of the operation. Often a method will be described in terms of operations in these flowcharts.

Several flowcharts include multiple operations. In certain aspects, any one of the operations may be found in an embodiment of the invention. In other aspects, multiple operations are needed in an embodiment of the invention. When multiple operations are needed, these operations may be performed concurrently, sequentially and/or in a combination of concurrent and sequential operations. The shapes of the arrows in multiple operation flowcharts may differ from one flowchart to another, and are not to be construed as having intrinsic meaning in interpreting the concurrency of the operations.

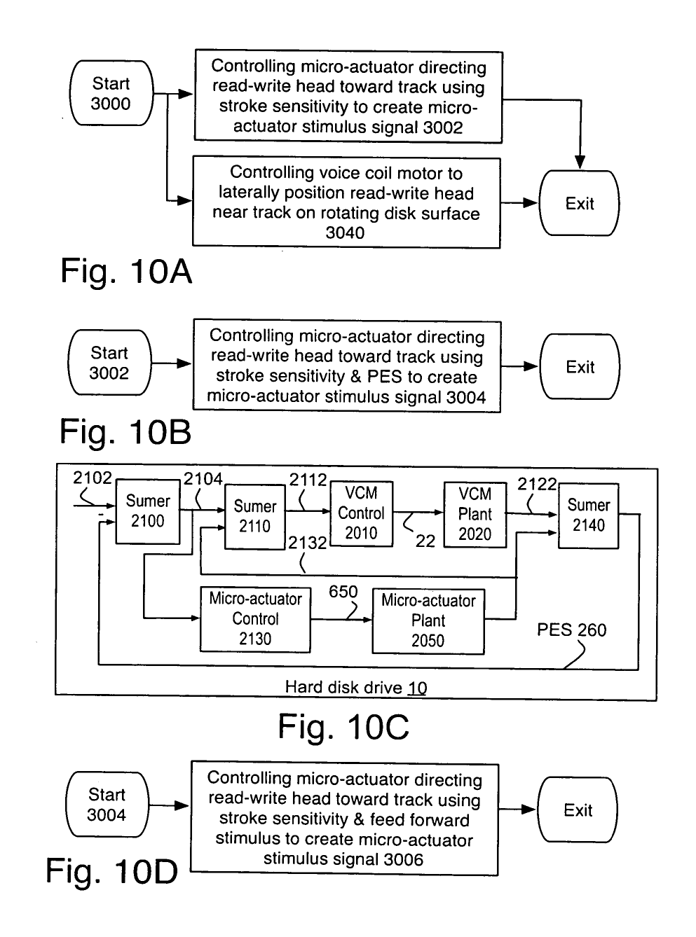

As mentioned before, the servo controller 600 may include a second program system 3000 as shown in FIGS. 1 and 9. The method of operating the micro-actuator 80 using the stroke sensitivity 634, will be discussed in terms of the second program system as shown in FIG. 9 and subsequent Figures. Operation 3002 supports controlling the micro-actuator 80 directing the read-write head 94 toward the track 122 using the stroke sensitivity 634 to create the micro-actuator stimulus signal 650, and operation 3040, which supports controlling the voice coil motor 18 to laterally position the read-write head 94 near the track 122 on the rotating disk surface 120-1, as shown in FIG. 10A. The micro-actuator may be further controlled using the stroke sensitivity and based upon the Position Error Signal 260 to create the micro-actuator stimulus signal, which is supported by Operation 3004 in FIG. 10B. The micro-actuator control 2130 of FIG. 10C may be implemented at least in part by Operation 3002 and/or 3004.

The method of using may further include subtracting 2100 the Position Error Signal 260 from the lateral positioning 2102 to create a feed-forward stimulus 2104, and controlling 2010 the voice coil motor based upon the feed-forward stimulus to create a voice coil stimulus 22. The first sumer 2100 subtracts the Position Error Signal 260 from the on track lateral control 2102 to create the feed-forward stimulus 2104. The means for controlling the voice coil motor is shown as the Voice Coil Motor Control 2010 of FIG. 10C. The means for controlling the micro-actuator 80 is shown as controlling the micro-actuator 2130, which may further include Operation 3006 of FIG. 10D controlling the micro-actuator using the stroke sensitivity 634 and based upon the feed-forward stimulus to create the micro-actuator stimulus signal 650.

Some further details, a third sumer 2110 subtracts the micro-actuator plant effect 2132 from the feed-forward stimulus 2104 to create the voice coil motor control input 2112. The voice coil motor plant 2020 generates a voice coil motor effect 2122, which is presented with the micro-actuator plant effect 2132 to the fourth sumer 2140 to create the Position Error Signal 260.

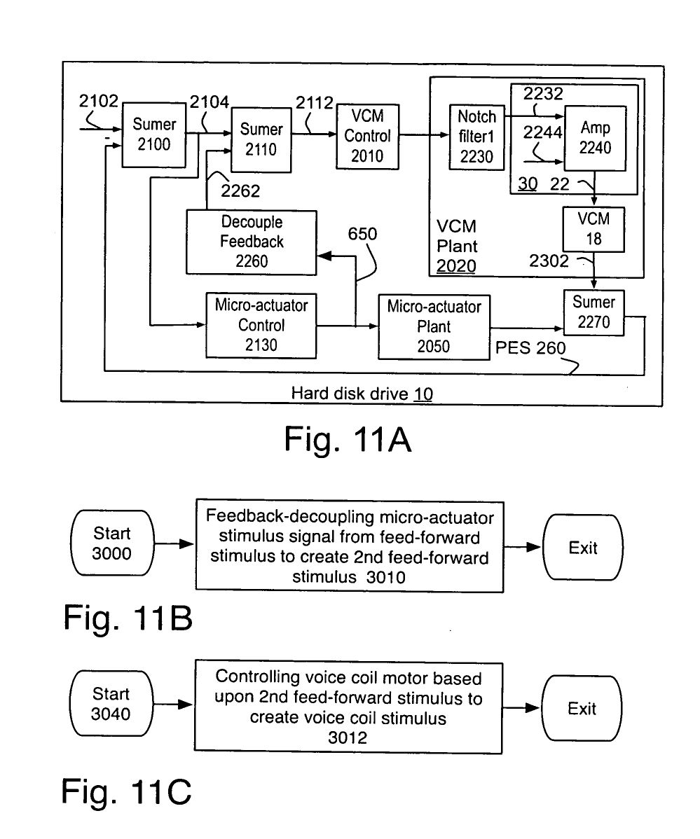

The method of using may include feedback-decoupling the micro-actuator stimulus signal 650 from the feed-forward stimulus 2104 to create a second feed-forward stimulus 2112, and controlling 2010 the voice coil motor 18 based upon the second feed-forward stimulus to create a voice coil stimulus 22, as shown in FIGS. 11A and 11B. This may be at least partly implemented within the second program system 3000 further including Operation 3010 supporting feedback-decoupling the micro-actuator stimulus signal from the feed-forward stimulus to create a second feed-forward stimulus. Operation 3040 supporting controlling the voice coil motor, may include Operation 3012, which supports controlling the voice coil motor based upon the second feed-forward stimulus to create a voice coil stimulus, as shown in FIG. 11C.

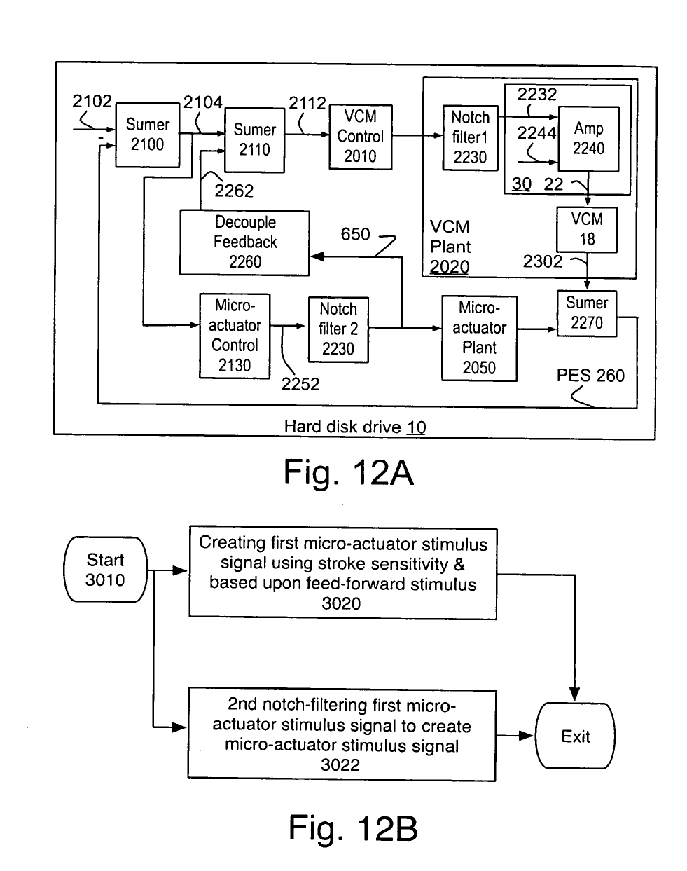

Further details relating to FIGS. 11A and 12A, regard the voice coil motor plant 2020, which may preferably include a first notch filter 2230 providing a notch filtered voice coil control 2232 to the voice coil driver 30, of FIGS. 1, 2 and 9, to create the voice coil signal 22. The voice coil driver may further preferably include a voice coil amplifier 2240. The voice coil amplifier may be driven by the notch filterer voice coil control, and sometimes also be a tuning gain 2244. The voice coil amplifier may preferably create the voice coil signal 22.

Controlling the micro-actuator 80 may further include creating a first micro-actuator stimulus signal 2252 using the stroke sensitivity 634 and based upon the feed-forward stimulus 2104, and second notch-filtering 2250 the first micro-actuator stimulus signal to create the micro-actuator stimulus signal 650, as shown in FIGS. 12A and 12B. Operation 3010 of FIG. 11B may further include Operation 3020 of FIG. 12B, supporting creating the first micro-actuator stimulus signal 2252 using the stroke sensitivity 634 and based upon the feed-forward stimulus 2104. And Operation 3022, which supports second notch-filtering the first micro-actuator stimulus signal to create the micro-actuator stimulus signal.

Making the servo controller 600 and/or the embedded circuit 500 may further include programming the memory 620 with the second program system 3000 to create the servo controller and/or the embedded circuit, preferably programming a non-volatile memory component of the memory.

The second program system 3000 may further support estimating the operational bandwidth 6678 of the micro-actuator 80. The operational bandwidth in certain instances may degrade over the life of the hard disk drive 10. When the operational bandwidth is non-functional the micro-actuator may be less useful, and in certain cases, may be non-functional.

While the method for estimating the stroke sensitivity may be implemented with more than one computer, and that computer may be specialized to implementing just a part of the process, the method will be discussed from hereon in terms of a single servo computer as shown in FIG. 1.

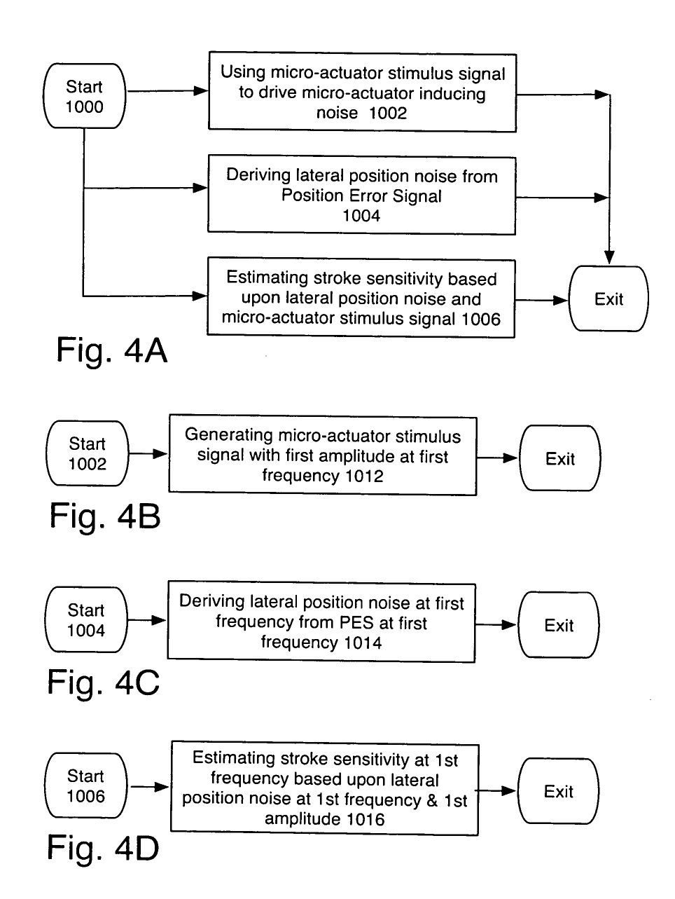

The method of estimating may be implemented by the program system 1000 shown in FIG. 1 and refined in FIG. 4A. Operation 1002 supports using 500 the micro-actuator stimulus signal 650 to drive the micro-actuator 80, inducing noise into the lateral positioning of the read-write head 94 near a track 122 by the voice coil motor 18 to create the Position Error Signal 260. Operation 1004 supports deriving 1510 the lateral position noise 638 from the Position Error Signal 260, which is often represented by a PES Count 640. Operation 1006 supports estimating 1520 the stroke sensitivity 634 based upon the lateral position noise and upon the micro-actuator stimulus signal.

The method of estimating the stroke sensitivity of FIG. 4A may be refined as shown in FIGS. 4B to 4D. Using the micro-actuator stimulus signal as shown in Operation 1002 may include Operation 1012 generating the micro-actuator stimulus signal 650 with a first amplitude 636 at a first frequency 630. Deriving the lateral position noise of Operation 1004 may include Operation 1014 supporting deriving the lateral position noise 638 at the first frequency from the Position Error Signal 260 at the first frequency. Estimating the stroke sensitivity of Operation 1006 may include Operation 1016 supporting estimating the stroke sensitivity 634 at the first frequency based upon the lateral position noise at the first frequency and upon the first amplitude.

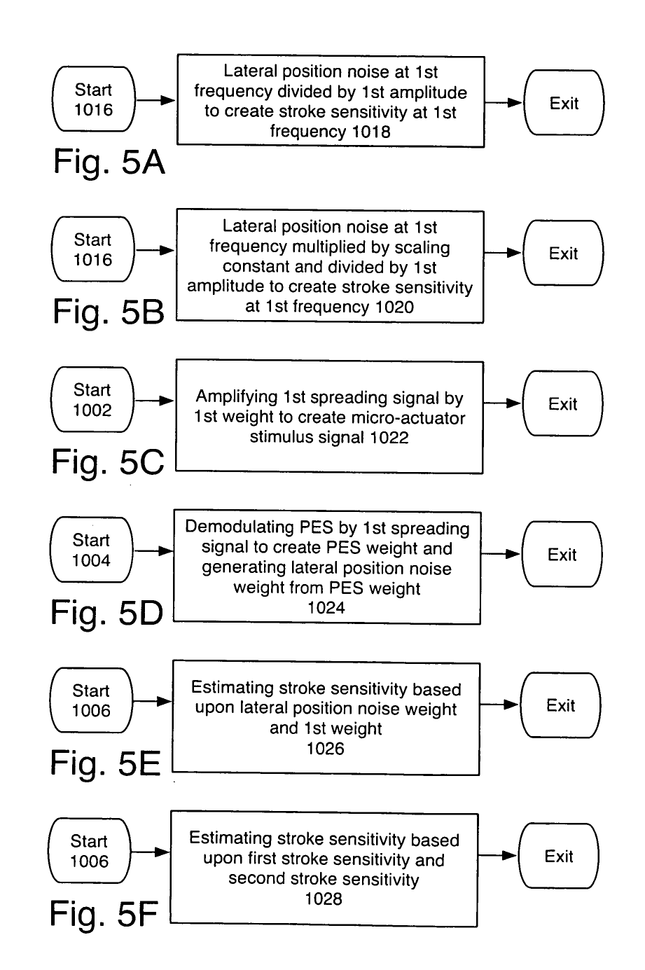

Estimating the stroke sensitivity of Operation 1016 may further include Operation 1018 of FIG. 5A supporting the lateral position noise 638 at the first frequency 630 divided by the first amplitude 636 to create the stroke sensitivity 634 at the first frequency. Further, the lateral position noise at the first frequency may be multiplied by a scaling constant 642, and divided by the first amplitude, to further create the stroke sensitivity at the first frequency, as supported by Operation 1020 of FIG. 5B.

Similarly, the micro-actuator stimulus signal 650 may be generated with the first amplitude 636 at a second frequency 632. A lateral position noise 638 at the second frequency may be derived from the Position Error Signal 260 at the second frequency. The stroke sensitivity 634 at the second frequency may be estimated based upon the lateral position noise at the second frequency and upon the first amplitude.

The stroke sensitivity 634 may be estimated based upon the stroke sensitivity at the first frequency 630 and upon the stroke sensitivity at the second frequency 632. This estimation may include, but is not limited to, the following. Averaging the stroke sensitivity at the first frequency and the stroke sensitivity at the second frequency to create the stroke sensitivity. Or, weighted-averaging the stroke sensitivity at the first frequency and the stroke sensitivity at the second frequency to create the stroke sensitivity.

In certain embodiments, a spread spectrum approach may be used to implement the method of estimating shown in FIG. 4A. Operation 1002 using 1500 the micro-actuator stimulus signal 650 may include Operation 1022 of FIG. 5C supporting amplifying a first spreading signal 644 by a first weight 646 to create the micro-actuator stimulus signal 650. Operation 1004 deriving 1510 the lateral position noise 638 may include Operation 1024 of FIG. 5D supporting demodulating the Position Error Signal 260 by the first spreading signal to create a PES weight 648 and generating a lateral position noise weight 654 from the PES weight. Operation 1006 estimating the stroke sensitivity may include Operation 1026 of FIG. 5E supporting estimating the stroke sensitivity 634 based upon the lateral position noise weight and upon the first weight.

Similarly to FIGS. 4C and 4D, estimating 1520 the stroke sensitivity 634 may include the lateral position noise weight 654 divided by the first weight 646 to create the stroke sensitivity. Estimating may further include the lateral position noise weight, multiplied by a scaling constant 642, and divided by the first weight to create the stroke sensitivity. The scaling constant used in this example based upon amplifying the spreading signal may differ from the scaling constant used with the example based upon the first frequency and the first amplitude.

Similarly to the discussion of FIGS. 5C to 5E, using 1500 the micro-actuator stimulus signal 650 may further include amplifying a second spreading signal 656 of FIG. 2 by a second weight 658 to create the micro-actuator stimulus signal. Deriving 1510 the lateral position noise 638 may further include demodulating the Position Error Signal 260 by the second spreading signal to create a second PES weight 660. Estimating 1520 the stroke sensitivity 634 may further include estimating a second stroke sensitivity 664 based upon the second lateral position noise and upon the second weight. Estimating the stroke sensitivity, as shown in Operation 1028 in FIG. 5F, may be based upon the stroke sensitivity estimated in FIG. 5E, which will be known as the first stroke sensitivity 662 and upon the second stroke sensitivity.

Similarly to the discussion of FIGS. 4C and 4D, Operation 1028 estimating 1520 the stroke sensitivity may include, but is not limited to, averaging the first stroke sensitivity 662 and the second stroke sensitivity 664 to create the stroke sensitivity 634, or weighted-averaging the first stroke sensitivity and the second stroke sensitivity to create the stroke sensitivity.

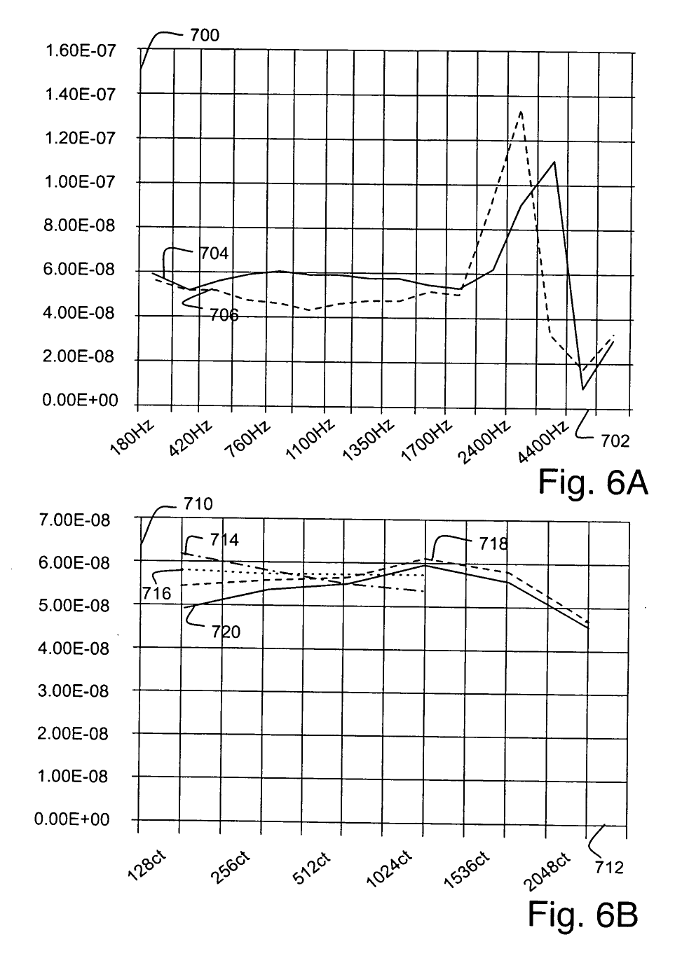

Consider some examples based upon experimental results, as shown in FIGS. 6A and 6B. Both Figures include a vertical axis and a horizontal axis.

FIG. 6A includes a first vertical axis 700, which represents the stroke sensitivity in units of nanometers per Volt, and a first horizontal axis 702, which represents the injection frequency in terms of Herz (Hz). First trace 704 shows the stroke sensitivity 634 of a first hard disk drive 10 for a first frequency 630 ranging from 180 Hz to 4400 Hz. Second trace 706 shows the stroke sensitivity of a second hard disk drive for a first frequency ranging from 180 Hz to 4400 Hz.

FIG. 6B includes a second vertical axis 710, which represents the stroke sensitivity of the first hard disk drive 10 used in FIG. 6A in units of nanometers per Volt, and a second horizontal axis 712, which represents the micro-actuator stimulus signal in terms of the micro-actuator driver's the digital to analog converter 280 of FIGS. 3E and 3F. The third trace 714 shows the stroke sensitivity 634 for a first frequency 630 of 540 Hz and the micro-actuator stimulus signal varying from 128 to 2048 counts. The fourth trace 716 shows the stroke sensitivity for a first frequency of 760 Hz and the micro-actuator stimulus signal varying from 128 to 2048 counts. The fifth trace 718 shows the stroke sensitivity for a first frequency of 1350 Hz and the micro-actuator stimulus signal varying from 128 to 1024 counts. The sixth trace 720 shows the stroke sensitivity for a first frequency of 1700 Hz and the micro-actuator stimulus signal varying from 128 to 1024 counts.

In both FIGS. 6A and 6B, the standard deviation of the lateral position noise for these experiments is essentially zero, which is the horizontal axis.

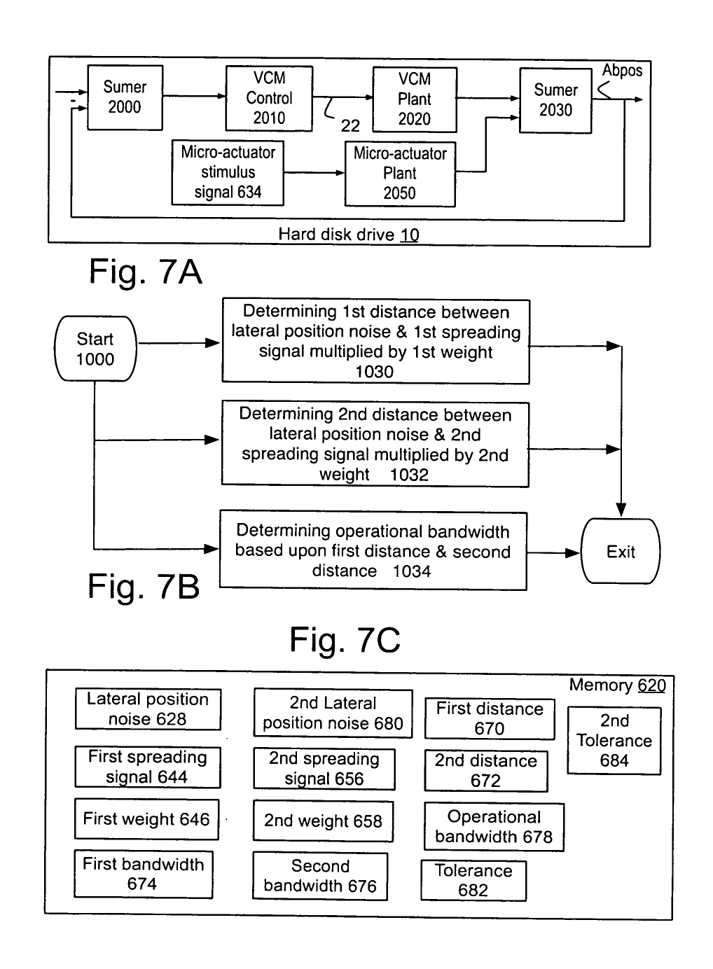

Consider the following model of the inventions method of estimating the stroke sensitivity 634 as shown in FIG. 7A when the voice coil motor 18 is in track-following mode, positioning the read-write head 94 near the track 122 on the rotating disk surface 120-1 as shown in FIGS. 1 and 2. The Voice Coil Motor Control 2010 drives the Voice Coil Motor Plant 2020 with the voice coil signal 22 and the micro-actuator stimulus signal 634 is injected into the Micro-actuator Plant 2050. These two effects are added by second sumer 2030 to create a state, which is the summed output of these two effects, called abpos. The transfer function from the injection of the micro-actuator stimulus to the summed output abpos is

$$TF = \frac{{P}_{2}}{1 + {P}_{1} {C}_{1}} = {ESF}_{VCM} * {P}_{2} \qquad ( 1.1 )$$

Where ESF_{VCM} denotes the Error Sensitivity Function of the Voice Coil Motor 18, P₁ denotes the effect of the Voice Coil Plant 2020, C₁ denotes the effect of the Voice Coil Motor Control 2010, and P₂ denotes the effect of the Micro-actuator Plant 2050. The error sensitivity function may be measured at a specific cylinder, more specifically, at a track number 652 for one or more frequencies of interest. The inventors have found that the frequency response of the error sensitivity function is flat up to a certain frequency, as shown in FIG. 6A.

The stroke sensitivity 634 may be defined as a Direct Current (DC) gain of the frequency response of the Error Sensitivity Function of the voice coil motor. More specifically, for a first frequency ω₀, the gain of P₂ may be calculated by

$$\vert {P}_{2} ( {ω}_{0} ) \vert = \vert \frac{1}{{ESF}_{VCM} ( {ω}_{0} )} \vert * \vert \frac{abpos ( {ω}_{0} )}{inj ( {ω}_{0} )} \vert \qquad ( 1.2 )$$

The magnitude of the ratio of the injection of the micro-actuator stimulus signal 634 to abpos may be obtained by performing a Fast Fourier Transform on the Position Error Signal 260. The calculated gain of P₂ at the frequency ω₀ is the DC gain of the frequency response of the micro-actuator 80, which closely approximates, and may often be, the stroke sensitivity 634.

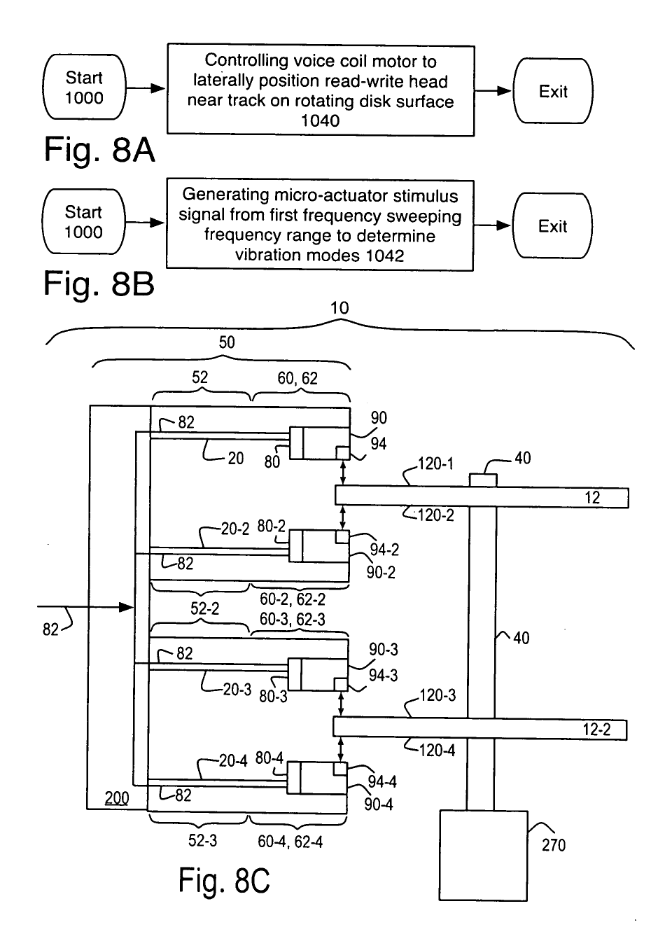

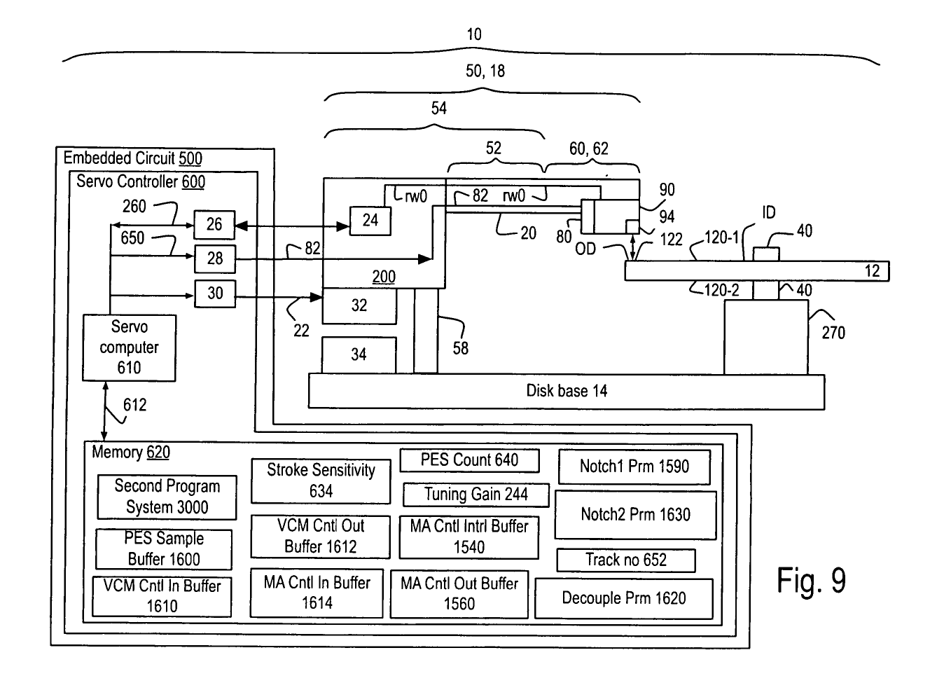

Additionally, by generating the micro-actuator stimulus signal 634 from the first frequency 630 by sweeping through a range of frequencies, vibration mode peaks can be identified up to the sampling frequency of the voice coil motor 18 while the hard disk drive 10 is in track-following mode, which is supported by Operation 1042 in FIG. 8B. This can often be done when the output of the Digital to Analog Converter 280 is set to twice the sampling frequency of the voice coil motor.

Consider estimating the stroke sensitivity 634 for a micro-actuator stimulus signal 650 at a first frequency 630, for example, at 540 Hz, and for the micro-actuator stimulus signal at a second frequency 632, at 1700 Hz, both with a first amplitude of 636 of 512 counts. The average of these stroke sensitivity estimates can be visually estimated from the third trace 714 and the sixth trace 720 of FIG. 6B. Preferably, the first frequency 630 and the second frequency 632 both belong within the range of flat frequency response for the micro-actuator 80.

Over time, the micro-actuator 80 in the hard disk drive 10 may not function as well as when it was manufactured. The range of flat frequency response may decline in bandwidth. Consider generating the micro-actuator stimulus signal may include a first spreading signal 644, which by way of example may have the form of a sum of sinusoidal signals, say at 420 Hz, 760 Hz, 1100 Hz, and 1350 Hz, which are all in the flat frequency response range of the micro-actuator 80 as shown in FIG. 6A. A second spreading signal 656 may have the form of a sum of the sinusoidal signals at 180 Hz, 420 Hz, 760 Hz, 1100 Hz, 1350 Hz, and 1700 Hz.

In this example, the first bandwidth 674, shown in FIG. 7C, which is the bandwidth of the first spreading signal 644 is contained in the second bandwidth 676, the bandwidth of the second spreading signal 656. Let's consider the example in further detail. Let

$${S}_{1} ( t ) ≡ {\sum }_{k = 1}^{4} sin ( {a}_{k} t + {b}_{k} ) and {S}_{2} ( t ) ≡ {\sum }_{k = 0}^{5} sin ( {a}_{k} t + {b}_{k} )$$

be the first spreading signal 644 and the second spreading signal 656, respectively. Let w, be the first weight 646, and w₂ be the second weight 658. Let s₁ be the first stroke sensitivity 662 estimated with the micro-actuator stimulus signal 650 generated by w₁S₁ (t), the first spreading signal multiplied by the first weight, creating N₁(t), the lateral position noise 628. Let s₂ be the second stroke sensitivity 664 estimated with the micro-actuator stimulus signal generated by w₂S₂ (t), the second spreading signal multiplied by the second weight, creating N₂ (t), the second lateral position noise 680.

In the following discussion, the integrals are over the same time interval, which provides sufficient samples to perform the FFT mentioned earlier.

Our first task will be to demodulate the lateral position noise 628, N₁(t) by the first spreading signal 644, S₁(t) and estimate the first stroke sensitivity 622, s₁. Decompose N₁(t)S₁(t) to the least square closest fit of

$${\sum }_{k = 1}^{4} {N}_{1 k} sin ( {a}_{k} t + {b}_{k} )$$

by minimizing the first Euclidean distance:

$$\begin{matrix}{E}_{1} ≡ \int {[ {N}_{1} ( t ) {S}_{1} ( t ) - {\sum }_{k = 1}^{4} {N}_{1 k} sin ( {a}_{k} t + {b}_{k} ) ]}^{2} ⅆ t \\ = \int {[ {\sum }_{k = 1}^{4} ( {N}_{1} ( t ) - {N}_{1 k} ) sin ( {a}_{k} t + {b}_{k} ) ]}^{2} ⅆ t\end{matrix} \qquad ( 1.3 )$$

which is a non-negative and smooth real-valued function of the N₁ₖ, and will have a minima when

$$\partial {E}_{1} / \partial {N}_{1 j} = 0 ,$$

=0, for each j=1, . . . , 4, which becomes

$$\begin{matrix}\frac{\partial {E}_{1}}{\partial {N}_{1 j}} = \frac{\partial }{\partial {N}_{1 j}} \int {[ {\sum }_{k = 1}^{4} ( {N}_{1} ( t ) - {N}_{1 k} ) sin ( {a}_{k} t + {b}_{k} ) ]}^{2} ⅆ t \\ = - 2 {N}_{1 j} \int [ {\sum }_{k = 1}^{4} ( {N}_{1} ( t ) - {N}_{1 k} ) sin ( {a}_{k} t + {b}_{k} ) ] sin ( {a}_{j} t + {b}_{j} ) ⅆ t \\ = - 2 {N}_{1 j} {\sum }_{k = 1}^{4} \int {N}_{1} ( t ) sin ( {a}_{k} t + {b}_{k} ) sin ( {a}_{j} t + {b}_{j} ) ⅆ t + \\ 2 {N}_{1 j} \int [ {\sum }_{k = 1}^{4} {N}_{1 k} sin ( {a}_{k} t + {b}_{k} ) ] sin ( {a}_{j} t + {b}_{j} ) ⅆ t\end{matrix} \qquad ( 1.4 )$$

Assuming for the moment that each N₁ⱼ≠0 allows the removal of 2_{Nj} as a common factor in the last version of (1.6) and applying

$$\partial {E}_{1} / \partial {N}_{1 j} = 0$$

yields the following linear system of equations for j=1, . . . 4:

$${\sum }_{k = 1}^{4} {N}_{1 k} \int sin ( {a}_{k} t + {b}_{k} ) sin ( {a}_{j} t + {b}_{j} ) ⅆ t = {\sum }_{k = 1}^{4} \int {N}_{1} ( t ) sin ( {a}_{k} t + {b}_{k} ) sin ( {a}_{j} t + {b}_{j} ) ⅆ t \qquad ( 1.5 )$$

which has a solution, N₁ⱼ for j=1, . . . , 4. Similarly estimate the first stroke sensitivity s₁ as minimizing

$${\sum }_{k = 1}^{4} {[ {N}_{1 k} - {s}_{1} {w}_{1} ]}^{2} \qquad ( 1.6 )$$

Again, this is a non-negative and smooth function of s₁, possessing a minimum when

$$\frac{ⅆ {\sum }_{k = 1}^{4} {[ {N}_{1 k} - {s}_{1} {w}_{1} ]}^{2}}{ⅆ {s}_{1}} = 0 \qquad ( 1.7 )$$

Further deriving this relationship

$$- 2 {w}_{1} {\sum }_{k = 1}^{4} [ {N}_{1 k} - {s}_{1} {w}_{1} ] = 0 \qquad ( 1.8 )$$

which assuming w₁≠0, becomes

$${\sum }_{k = 1}^{4} {N}_{1 k} = 4 {s}_{1} {w}_{1}$$

and makes

$${s}_{1} = {\sum }_{k = 1}^{4} {N}_{1 k} / 4 {w}_{1} \qquad ( 1.9 )$$

Now demodulating the second lateral position noise 680, N₂ (t) by the second spreading signal 656, S₂ (t) and estimating the second stroke sensitivity 664, s₂. Decompose N₂(t)S₂(t) to the least square closest fit of

$${\sum }_{k = 0}^{5} {N}_{2 k} sin ( {a}_{k} t + {b}_{k} )$$

by minimizing the second Euclidean distance:

$${E}_{2} ≡ \int {[ {N}_{2} ( t ) {S}_{2} ( t ) - {\sum }_{k = 0}^{5} {N}_{2 k} sin ( {a}_{k} t + {b}_{k} ) ]}^{2} ⅆ t \qquad ( 1.10 )$$

which is a non-negative and smooth real-valued function of the N₂ₖ, and will have a minima when

$$\partial {E}_{1} / \partial {N}_{1 j} = 0 ,$$

=0, for each j=1, . . . ,4, which leads in a similar fashion to the following linear system of equations for j=0, . . . , 5:

$${\sum }_{k = 0}^{5} {N}_{2 k} \int sin ( {a}_{k} t + {b}_{k} ) sin ( {a}_{j} t + {b}_{j} ) ⅆ t = {\sum }_{k = 0}^{5} \int {N}_{2} ( t ) sin ( {a}_{k} t + {b}_{k} ) sin ( {a}_{j} t + {b}_{j} ) ⅆ t \qquad ( 1.11 )$$

which has a solution, N₂ⱼ for j=0, . . . , 5. Similarly estimate the first stroke sensitivity s₁ as minimizing

$${\sum }_{k = 0}^{5} {[ {N}_{2 k} - {s}_{2} {w}_{2} ]}^{2} \qquad ( 1.12 )$$

Again, this is a non-negative and smooth function of s₂, possessing a minimum when

$$\frac{ⅆ {\sum }_{k = 0}^{5} {[ {N}_{2 k} - {s}_{2} {w}_{2} ]}^{2}}{ⅆ {s}_{2}} = 0 \qquad ( 1.13 )$$

which assuming w₁≠0, leads to

$${s}_{2} = {\sum }_{k = 0}^{5} {N}_{2 k} / 6 {w}_{2} \qquad ( 1.14 )$$

The method, shown here as a refinement of the example implementation of the program system 1000 of FIG. 1 may further include the following, as shown in FIG. 7B. Operation 1030 supports determining a first distance 670 between the lateral position noise 638 and the first spreading signal 644 multiplied by the first weight 646. Operation 1032 supports determining a second distance 672 between the second lateral position noise 680 and the second spreading signal 656 multiplied by the second weight 658. Operation 1034 supports determining an operational bandwidth 678 for the micro-actuator 80 based upon the first distance for the bandwidth of the first spreading signal and based upon the second distance for the bandwidth of the second spreading signal.

To further develop our example, calculate the first distance 670 as

$${F}_{1} ≡ {\sum }_{k = 1}^{4} {[ {N}_{1 k} - {s}_{1} {w}_{1} ]}^{2} \qquad ( 1.15 )$$

and calculate the second distance 672 as

$${F}_{2} ≡ {\sum }_{k = 0}^{5} {[ {N}_{2 k} - {s}_{2} {w}_{2} ]}^{2} . \qquad ( 1.16 )$$

Determining the operational bandwidth 678 may be done in a variety of ways. For example, when the first distance 670 is within a tolerance 682 of the second distance 672, the operational bandwidth 678 may be the second bandwidth 676, the bandwidth of the second spreading signal 656. When the first distance is more than the tolerance from the second distance, the operational bandwidth may be the first bandwidth 674, the bandwidth of the first spreading signal 644.

Alternatively and/or additionally, when the second distance 672 is less than a second tolerance 684, the operational bandwidth 678 may be the second bandwidth 676, the bandwidth of the second spreading signal 656. And when the first distance 670 is less than the second tolerance and the second distance is greater than the second tolerance, the operational bandwidth may be the first bandwidth 674, the bandwidth of the first spreading signal 644. The method may include various alternatives and refinements. When the second distance is less than or equal to the second tolerance, the operational bandwidth may be the bandwidth of the second spreading signal. And when the first distance is less than or equal to the second tolerance and the second distance is greater than the second tolerance, the operational bandwidth may be the bandwidth of the first spreading signal. Another alternative, when the first distance is less than the second tolerance and the second distance is greater than or equal to the second tolerance, the operational bandwidth may be the bandwidth of the first spreading signal.

Determining the operational bandwidth 678 may include when the first distance 670 is greater than the second tolerance 684, the operational bandwidth is non-functional. In certain embodiments, the operational bandwidth being non-functional may include a bandwidth of 0 Hz.

The method of operating the hard disk drive may be implemented by the program system 1000 of FIGS. 1, 4A to 5F, and 7B to include operation 1040 of FIG. 8A, controlling the voice coil motor 18 to laterally position the read-write head 94 near the track 122 on the rotating disk surface 120-1.

In certain embodiments, the method of estimating may be used to create the stroke sensitivity 634 during the initialization/calibration phase of manufacturing the hard disk drive 10. This stage often occurs after the hard disk drive is assembled. The method estimates the stroke sensitivity for at least one micro-actuator 80. If the hard disk drive includes more than one micro-actuator as in FIG. 8B, the method may preferably perform the estimate for each of the micro-actuators.

During the initialization/calibration phase, the stroke sensitivity 634 may preferably be estimated for more than one track 122. Often the stroke sensitivity for one or more tracks near the inside diameter ID and/or one or more tracks near the outside diameter OD are estimated. In certain embodiments, a table of stroke sensitivity estimates is constructed for collections of adjacent tracks on the rotating disk surface is created and used.

The method of estimating may be implemented as the program system 1000 with its program steps residing in a volatile memory component of the memory 620, the stroke sensitivity 634 estimate or estimates are the product of this manufacturing process, which are usually stored in a non-volatile memory component of the memory. Alternatively, the program system 1000 may be implemented with its program steps residing in a non-volatile memory component of the memory 620. These embodiments are useful in estimate the stroke sensitivity throughout the life of the hard disk drive 10.

As previously mentioned, the embedded circuit 500 may include the servo controller 600. A hard disk drive 10 may include the servo controller, and possibly the embedded circuit, coupled to the voice coil motor 18, to provide the micro-actuator stimulus signal 650 driving the micro-actuator 80, and a read differential signal pair contained in the read and write differential signal pairs rw0 from the read-write head 94 to the servo controller to generate the Position Error Signal 260.

Making the embedded circuit 500, and in some embodiments, the servo controller 600, may include installing the servo computer 610 and the memory 620 into the servo controller and programming the memory with the program system 1000 to create the servo controller and/or the embedded circuit. Making the embedded circuits and/or the servo controller, may include installing at least one of the means for using 1500, the means for deriving 1510, and the means for estimating 1520 to create the servo controller and/or the embedded circuit.

The invention's hard disk drive 10 may include the servo controller 600 and/or the embedded circuit 500 coupled to the voice coil motor 18, to provide the micro-actuator stimulus signal 650 driving the micro-actuator 80, and a read differential signal pair as part of the read and write differential signal pairs rw0 from the read-write head 94 to the servo controller to generate the Position Error Signal 260.

Making the hard disk drive 10 may include coupling the servo controller 600 and/or the embedded circuit 500 to the voice coil motor 18, providing the micro-actuator stimulus signal 650 to drive the micro-actuator 80, and the read and write differential signal pairs rw0 include a read differential signal pair from the read-write head to the servo controller to generate the Position Error Signal 260.

Looking at some of the details of FIGS. 1, 2, 8B, and 9, the hard disk drive 10 includes a disk 12 and a second disk 12-2. The disk includes the rotating disk surface 120-1 and a second rotating disk surface 120-2. The second disk includes a third rotating disk surface 120-3 and a fourth rotating disk surface 120-4. The voice coil motor 18 includes an head stack assembly 50 pivoting through an actuator pivot 58 mounted on the disk base 14, in response to the voice coil 32 mounted on the head stack 54 interacting with the fixed magnet 34 mounted on the disk base. The actuator assembly includes the head stack with at least one actuator arm 52 coupling to a slider 90 containing the read-write head 94. The slider is coupled to the micro-actuator 80.

FIG. 9 further shows the head stack assembly including more than one actuator arm, in particular, a second actuator arm 52-2 and a third actuator arm 52-3. Each of the actuator arms is coupled to at least one slider, in particular, the second actuator arm couples to a second slider 90-2 and a third slider 90-3, and the third actuator arm couples to a fourth slider 90-4. Each of these sliders contains a read-write head, for example, the second slider contains the second read-write head 94-2, the third slider contains the third read-write head 94-3, and the fourth slider contains the fourth read-write head 94-4. Each of these sliders is preferably coupled to a micro-actuator, for example, the second slider is coupled to the second micro-actuator 80-2, the third slider is coupled to the third micro-actuator 80-3, and the fourth slider is coupled to the fourth micro-actuator 80-4.

The read-write head 94 interfaces through a preamplifier 24 on a main flex circuit 200 using a read and write differential signals rw0 typically provided by the flexure finger 20, to a channel interface 26 often located within the servo controller 600. The channel interface often provides the Position Error Signal 260 (PES) within the servo controller. It may be preferred that the micro-actuator stimulus signal 650 be shared when the hard disk drive includes more than one micro-actuator. It may be further preferred that the lateral control signal 82 be shared, as shown in FIG. 8B. Typically, each read-write head interfaces with the preamplifier using a separate read and write differential signal pair, typically provided by a separate flexure finger. For example, the second read-write head 94-2 interfaces with the preamplifier via a second flexure finger 20-2, the third read-write head 94-3 via the a third flexure finger 20-3, and the fourth read-write head 94-4 via a fourth flexure finger 20-4.

Returning to FIG. 9, a PES sample buffer 1600 may store a succession of the Position Error Signal 260 readings, which are often preferably represented as the PES count 640. A voice coil motor control input buffer 1610 may include a succession of inputs to the voice coil motor control 2010 of FIGS. 7A, 10C, 11A, and 12A. A voice coil motor control output buffer 1612 may include a succession of outputs from the voice coil motor control. A micro-actuator control input buffer 1614 may include a succession of inputs to the micro-actuator control 2130, a micro-actuator control internal buffer 1540 may include a succession of internal values, and a micro-actuator control output buffer 1560 may include a succession of outputs from the micro-actuator control. The first notch filter 2230 may be directed by the first notch filter parameter list 1590. The second notch filer 2250 may be directed by the second notch filter parameter list 1630. Feedback-decoupling 2260 may be directed by a decoupling filter parameter list 1620.

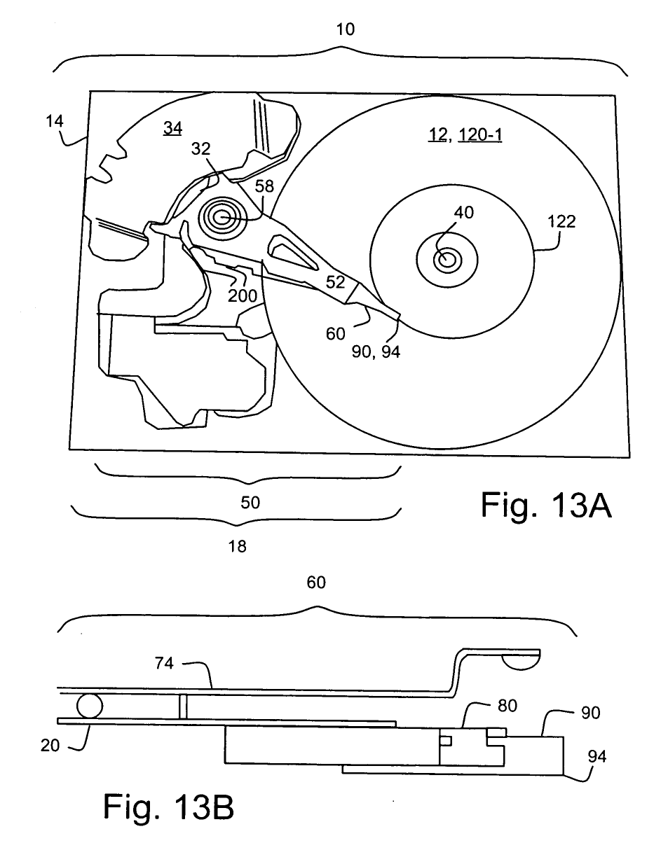

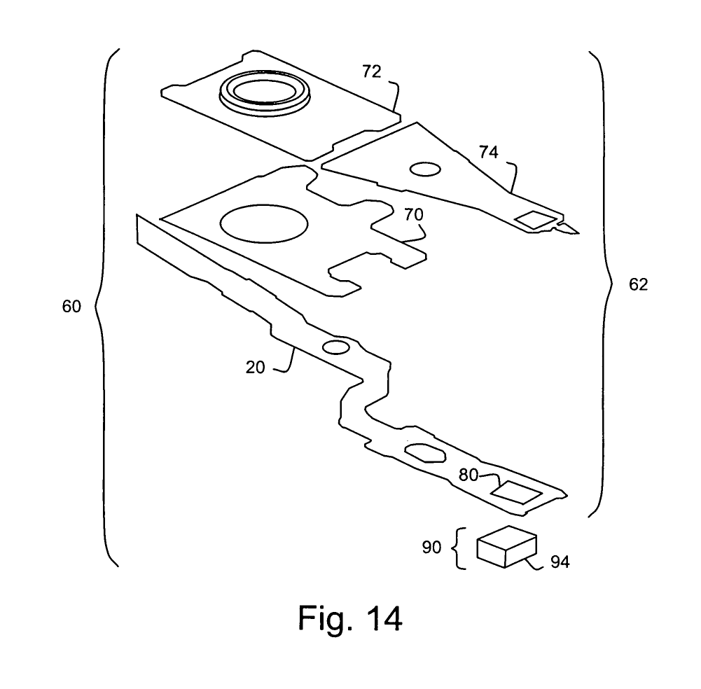

Returning to FIGS. 1, 2, 9, 10C, 11A, 12A and 13A, the slider 90 is mounted on a head gimbal assembly 60, which is coupled to the actuator arm 52. FIGS. 13B and 14 show a side view and an exploded view of the head gimbal assembly. A head suspension assembly 62 is often used as a basis for building the head gimbal assembly. Both the head suspension assembly and the head gimbal assembly include a base plate 72 coupled through a hinge 70 to a load beam 74. Often the flexure finger 20 is coupled to the load beam and the micro-actuator 80 and slider 90 are coupled through the flexure finger to the head gimbal assembly.

The micro-actuator 80 as used herein preferably provides lateral positioning of the read-write head 94 near the track 122. In certain embodiments the micro-actuator may also provided vertical positioning. The micro-actuator may use a piezoelectric effect and/or an electro-static effect in providing lateral and/or vertical positioning.

During normal disk access operations, the embedded circuit 500 and/or the servo controller 600 direct the spindle motor 270 to rotate the spindle shaft 40. This rotating is very stable, providing a nearly constant rotational rate through the spindle shaft to at least one disk 12, and as shown in some of the Figures, sometimes more than one disk. The rotation of the disk creates the rotating disk surface 120-1, used to access the track 122 during track following mode, as discussed elsewhere. These accesses normally provide for reading the track and/or writing the track.

Returning to FIG. 8C, the actuator arm 52 couples through the head gimbal assembly 60 to the slider 90, its read-write head 94, the micro-actuator 80 and the flexure finger 20 electrically coupling the lateral control signal 82 to the micro-actuator. The second actuator arm 52-2 couples through the second head gimbal assembly 60-2 to the second slider 90-2, its second read-write head 94-2, the second micro-actuator 80-2 and the second flexure finger 20-2 electrically coupling the lateral control signal to the second micro-actuator. The second actuator arm 52-2 also couples through the third head gimbal assembly 60-3 to the third slider 90-3, its third read-write head 94-3, the third micro-actuator 80-3 and the third flexure finger 20-3 electrically coupling the lateral control signal to the third micro-actuator. The third actuator arm 52-3 couples through the fourth head gimbal assembly 60-4 to the fourth slider 90-4, its fourth read-write head 94-4, the fourth micro-actuator 80-4 and the fourth flexure finger 20-4 electrically coupling the lateral control signal to the fourth micro-actuator.

The preceding embodiments provide examples of the invention and are not meant to constrain the scope of the following claims.

What is claimed is:

1. A method of operating a micro-actuator, comprising the step:
controlling said micro-actuator directing a read-write head toward a track using a stroke sensitivity to create a micro-actuator stimulus signal; wherein said micro-actuator is coupled to a slider including said read-write head near a rotating disk surface containing a track;
wherein said stroke sensitivity is the product of the method of estimating, comprising the steps:
using said micro-actuator stimulus signal driving said micro-actuator to induce noise into the lateral positioning of said read-write head near said track by the voice coil motor to create the Position Error Signal;
deriving the lateral position noise from said Position Error Signal; and
estimating said stroke sensitivity based upon said lateral position noise and upon said micro-actuator stimulus signal.

2. The method of claim 1, wherein the step controlling said micro-actuator further comprises the step:
controlling said micro-actuator to direct said read-write head toward said track using said stroke sensitivity and based upon said Position Error Signal to create said micro-actuator stimulus signal.

3. The method of claim 1, further comprising the steps:
subtracting said Position Error Signal from said lateral positioning to create a feed-forward stimulus; and
controlling said voice coil motor based upon said feed-forward stimulus to create a voice coil stimulus;
wherein the step controlling said micro-actuator, further comprises the step:
controlling said micro-actuator using said stroke sensitivity and based upon said feed-forward stimulus to create said micro-actuator stimulus signal.

4. The method of claim 3, wherein the step controlling said voice coil motor, further comprises the steps:
feedback-decoupling said micro-actuator stimulus signal from said feed-forward stimulus to create a second feed-forward stimulus; and
controlling said voice coil motor based upon said second feed-forward stimulus to create a voice coil stimulus.

5. The method of claim 4, wherein the step controlling said micro-actuator, further comprises the steps:
creating a first micro-actuator stimulus signal using said stroke sensitivity and based upon said feed-forward stimulus; and
second notch-filtering said first micro-actuator stimulus signal to create said micro-actuator stimulus signal.

6. A servo controller including apparatus supporting the implementation of the method of claim 1.

7. The servo controller of claim 6, comprising: a servo computer accessibly coupled to a memory and directed by a second program system including program steps residing in said memory; wherein said second program system comprises the program step:
controlling said micro-actuator directing said read-write head toward said track using said stroke sensitivity to create said micro-actuator stimulus signal.

8. The servo controller of claim 7, wherein said second program system, further comprises the program step:
controlling said voice coil motor to laterally position said read-write head near said track on said rotating disk surface.

9. The servo controller of claim 7, further comprises:
said micro-actuator stimulus signal driving a micro-actuator driver providing a lateral control signal to said micro-actuator;
wherein said micro-actuator responds to said lateral control signal to induce said noise into said lateral positioning of said read-write head near said track by said voice coil motor.

10. The servo controller of claim 9, wherein said micro-actuator stimulus signal driving said micro-actuator driver, further comprises:
said micro-actuator stimulus signal feeding a digital to analog converter providing a first micro-actuator driving signal contributing to said lateral control signal.

11. The servo controller of claim 10, wherein said micro-actuator stimulus signal feeding said digital to analog converter, further comprises:
said micro-actuator driving signal presented to a first amplifier providing a first amplified signal further contributing to said lateral control signal.

12. The servo controller of claim 11, wherein said first amplifier providing said first amplified signal further comprising:
said first amplified signal presented to a first filter to provide said lateral control signal.

13. The servo controller of claim 10, wherein said micro-actuator stimulus signal drives said micro-actuator driver, further comprises:
said first micro-actuator driving signal is presented to a second filter providing a second filtered signal further contributing to said lateral control signal.

14. The servo controller of claim 13, wherein said second filter providing said second filtered signal, further comprises:
said second filtered signal is presented to a second amplifier providing said lateral control signal.

15. The servo controller of claim 6, comprising:
means for controlling said voice coil motor to laterally position said read-write head near said track on said rotating disk surface; and
means for controlling said micro-actuator directing said read-write head toward said track using said stroke sensitivity to create said micro-actuator stimulus signal.

16. The servo controller of claim 15,
wherein at least one member of a means group includes, at least one member of the group consisting of:
a computer accessibly coupled to a memory and directed by a program system including at least one program step residing in said memory;
a finite state machine; and
an Application Specific Integrated Circuit (ASIC);
wherein said members of said means group, consist of: said means for controlling said voice coil motor, and said means for controlling said micro-actuator;
wherein said computer includes at least one instruction processor and at least one data processor; and
wherein each of said data processors is directed by at least one of said instruction processors.

17. An embedded circuit, comprising said servo controller of claim 6.

18. A method of manufacturing said embedded circuit of claim 17, comprising at least one of the group consisting of the steps:
installing a servo computer, a second program system, and a memory into said servo controller to create said embedded circuit, further comprising the step: programming said memory with said second program system; and
installing a means for controlling said voice coil motor and a means for controlling said micro-actuator to create said embedded circuit.

19. The embedded circuit as a product of the process of claim 18.

20. A hard disk drive, comprising at least one member of the group consisting of:
said embedded circuit of claim 17 coupled to said voice coil motor, to provide said micro-actuator stimulus signal driving said micro-actuator, and a read differential signal pair from said read-write head to said servo controller to generate said Position Error Signal; and
said servo controller coupled to said voice coil motor, to provide said micro-actuator stimulus signal driving said micro-actuator, and said read differential signal pair from said read-write head to said servo controller to generate said Position Error Signal.

21. A method of manufacturing said hard disk drive of claim 20, comprising at least one member of the group consisting of the steps:
coupling said embedded circuit to said voice coil motor, providing said micro-actuator stimulus signal to drive said micro-actuator, and a read differential signal pair from said read-write head to said servo controller to generate said Position Error Signal, to create said hard disk drive; and
coupling said servo controller to said voice coil motor, providing said micro-actuator stimulus signal to drive said micro-actuator, and a read differential signal pair from said read-write head to said servo controller to generate said Position Error Signal, to create said hard disk drive.

22. The hard disk drive as a product of the process of claim 21.
